(19) United States
(12) Patent Application Publication
(10) Pub. No.: US 2025/0297097 A1
(43) Pub. Date: Sep. 25, 2025

(54) Self-Recyclable Polymer Composites and Methods of Making and Using Thereof

(71) Applicant: UNIVERSITY OF KANSAS, Lawrence, KS (US)

(72) Inventors: Ana Rita Colaco MORAIS, Lawrence, KS (US); Lakshmiprasad GURRALA, Lawrence, KS (US)

(21) Appl. No.: 19/084,624

(22) Filed: Mar. 19, 2025

Related U.S. Application Data
(60) Provisional application No. 63/567,162, filed on Mar. 19, 2024.

(51) Int. Cl. C08L 67/02; C08J 11/26; C08L 77/02; C08L 77/06

(52) U.S. Cl. CPC C08L 67/02; C08J 11/26; C08L 77/02; C08L 77/06; C08J 2367/02; C08J 2377/02; C08J 2377/06; C08J 2425/18; C08J 2453/00; C08L 2201/06

(57) ABSTRACT

Described herein are self-recyclable polymeric compositions. The polymeric compositions can comprise a blend of a matrix polymer and a triggerable polymer. The triggerable polymer can be derived from a monomer that generates or releases an acid upon activation, a monomer that generates or releases a blowing agent upon activation, or any combination thereof. When triggered (e.g., by heating), the triggerable polymer can generate or release an acid and/or a blowing agent, degrading (e.g., depolymerizing) the matrix polymer.

### CROSS-REFERENCE TO RELATED APPLICATIONS

This application claims benefit of priority of U.S. Provisional Application No. 63/567,162, filed Mar. 19, 2024, which is incorporated herein by reference in its entirety.

### BACKGROUND

Plastics are ubiquitous in the modern world, but effective end-of-life options are currently lacking. Plastic packaging uses nearly 40% of all polymers, a substantial share of which is used for consumer products, such as personal care packages (e.g., shampoo, conditioner, and soap bottles) and household packages (e.g., for laundry detergent and cleaning compositions). There is a significant need for improved polymeric compositions, including polymeric composite materials for used in packaging applications, with improved recyclability. The polymer compositions, articles, and methods described herein address these and other needs.

### SUMMARY

Described herein are self-recyclable polymeric compositions. The polymeric compositions can comprise a blend of a matrix polymer and a triggerable polymer. In some embodiments, the triggerable polymer can be miscible in the matrix polymer. The triggerable polymer can be derived from a monomer that generates or releases an acid upon activation, a monomer that generates or releases a blowing agent upon activation, or any combination thereof. When triggered (e.g., by heating as discussed in more detail below), the triggerable polymer can generate or release an acid and/or a blowing agent, thereby degrading (e.g., depolymerizing) the matrix polymer.

In some embodiments, the matrix polymer comprises a polymer that is susceptible to acid hydrolysis. For example, the matrix polymer can comprise a polyester (e.g., PET), a polyamide (e.g., nylon 6 and/or nylon 66), a polycarbonate, a polysaccharide, a copolymer thereof, or a blend thereof.

In some embodiments, the triggerable polymer comprises a copolymer, such as a block copolymer or a random copolymer. In some embodiments, the triggerable polymer is derived from a monomer that generates or releases the acid upon thermal activation, a monomer that generates or releases the blowing agent upon thermal activation, or any combination thereof.

In some embodiments, the acid comprises carbonic acid (e.g., generated by the release of carbon dioxide in an aqueous solution) or an organic acid, such as acetic acid.

In some embodiments, the blowing agent comprises carbon dioxide.

The triggerable polymer can be present in the polymeric composition in varying amounts. In some embodiments, the triggerable polymer can be present in the polymeric composition in an amount of from 1% by weight to 25% by weight, based on the total weight of the polymeric composition.

In certain embodiments, the triggerable polymer can be derived from a monomer that generates or releases the acid and the blowing agent upon thermal activation. For example, the triggerable polymer can be derived from a monomer that generates or releases carbon dioxide. The carbon dioxide can generate carbonic acid in the presence of water while also serving as a blowing agent.

In other embodiments, the triggerable polymer is derived from a first monomer that generates or releases the acid upon thermal activation (e.g., a monomer that releases an organic acid such as acetic acid upon activation) and a second monomer that generates or releases the blowing agent (e.g., carbon dioxide) upon thermal activation.

In some embodiments, the triggerable polymer comprises a polyvinyl phenol backbone functionalized with alkyl carbonate moieties, ester moieties, or a combination thereof. In some examples, the triggerable polymer is derived (as least in part) from a monomer comprising 4-acetoxystyrene. In some examples, the triggerable polymer is derived (as least in part) from a monomer comprising an alkyl-4-vinylphenyl carbonate, such as n-butyl-4-vinylphenyl carbonate, iso-butyl-4-vinylphenyl carbonate, neopentyl-4-vinylphenyl carbonate, or tert-butyl-4-vinylphenyl carbonate.

The matrix polymer can exhibit a glass transition temperature (T_{g}) and a melting temperature (Tₘ). In some embodiments, the monomer exhibits an activation temperature (at which the acid is generated or released and/or the blowing agent is generated or released) of greater than T_{g}, but less than Tₘ. In some embodiments, when the composition is heated to a temperature greater than T_{g}, but less than Tₘ, the monomer generates or releases the acid, the monomer generates or releases the blowing agent, or a combination thereof. In certain embodiments, when the composition is heated to a temperature greater than T_{g}, but less than Tₘ in the presence of water, the matrix polymer undergoes depolymerization.

Also described herein are articles formed, at least in part, from the polymeric compositions described herein.

Also provided are methods for recycling the polymeric compositions described herein. These methods can comprise heating the composition to a temperature greater than an activation temperature of the monomer (at which the acid is generated or released and/or the blowing agent is generated or released) in the presence of water. Also provided are methods for recycling the polymeric compositions described herein that comprise heating the composition to a temperature greater than a glass transition temperature (T_{g}) of the matrix polymer but less than a melting temperature (Tₘ) of the matrix polymer in the presence of water.

### DESCRIPTION OF DRAWINGS

FIG. 1. Schematic flow chat illustrating the synthesis of example PVP-PET composites.

FIG. 2. Schematic for post reaction steps for polymer hydrolysis.

FIGS. 3A-3B. ATR-FTIR (FIG. 3A) and TGA and DTA (FIG. 3B) of pristine and carbonate functionalized PVP.

FIGS. 4A-4B. ATR-FTIR (FIG. 4A) and TGA, and DTA (FIG. 4B) of pristine PET, PVP and different wt. % loaded PVP-PET.

FIGS. 5A-5B. ATR-FTIR (FIG. 5A) and TGA and DTA (FIG. 5B) of pristine PET, PVPs and 10 wt. % functional PVPs-PET composites.

FIG. 6. X-Ray diffractogram of PET film and functionalized PVP-PET composite films.

FIG. 7. Heat flow DSC of PET film and functionalized PVP-PET composite films.

FIG. 8. Plot summarizing the H₂O hydrolysis of self-catalyzed polyester PET. Reaction conditions: polymer (2 g), H₂O (20 mL), initial N₂ pressure (20 bar), temperature (180° C.), time (30 min) and N₂ pressure at 180° C. (bar).

FIG. 9. Graphic illustrating example mechanisms by which the polymeric compositions described herein can be recycled.

### DETAILED DESCRIPTION

### Definitions

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers. Homopolymers (i.e., a single repeating unit) and copolymers (i.e., more than one repeating unit) are two categories of polymers.

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “molecular weight” (MW) refers to the mass of one molecule of that substance, relative to the unified atomic mass unit u (equal to 1/12 the mass of one atom of carbon-12).

As used herein, the term “number average molecular weight” (Mₙ) refers to the common, mean, average of the molecular weights of the individual polymers. Mₙ can be determined by measuring the molecular weight of n polymer molecules, summing the weights, and dividing by n. The number average molecular weight of a polymer can be determined by gel permeation chromatography, viscometry (Mark-Houwink equation), light scattering, analytical ultracentrifugation, vapor pressure osmometry, end-group titration, and colligative properties.

As used herein, the term “weight average molecular weight” (M_{w}) refers to an alternative measure of the molecular weight of a polymer. Intuitively, if the weight average molecular weight is w, and a random monomer is selected, then the polymer it belongs to will have a weight of w, on average. The weight average molecular weight can be determined by light scattering, small angle neutron scattering (SANS), X-ray scattering, and sedimentation velocity.

As used herein, the terms “polydispersity” and “polydispersity index” refer to the ratio of the weight average to the number average (M_{w}/Mₙ).

As used herein, the terms “polyethylene terephthalate” and “PET” refer to a thermoplastic polyester resin that can exist both as an amorphous (transparent) and as a semicrystalline (opaque and white) material. PET can also exist as a semicrystalline transparent material, as used in the side walls of PET bottles. In such aspects, the crystals are smaller than the wavelength of visible light and thus do not make the material opaque and white. PET can be represented with the following structural formula:

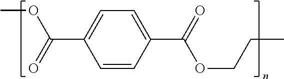

PET can be used in synthetic fibers; beverage, food and other liquid containers; thermoforming applications; and engineering resins, often in combination with glass fiber. Its monomer can be synthesized by the esterification reaction between terephthalic acid and ethylene glycol with water as a byproduct, or the transesterification reaction between ethylene glycol and dimethyl terephthalate with methanol as a byproduct. Polymerization can be through a polycondensation reaction of the monomers with ethylene glycol as the byproduct.

The terms “polyethylene terephthalate” and “PET” include both PET polymers and copolymers. For example, PET can be provided as a copolymer having, in addition to terephthalic acid residues and ethylene glycol residues, additional isophthalic acid residues and/or cycloheanedimethanol residues. It is also understood that PET polymer and/or copolymer can be provided as part of a polymer blend.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Polymeric Compositions

Described herein are self-recyclable polymeric compositions. The polymeric compositions can comprise a blend of a matrix polymer and a triggerable polymer. In some embodiments, the triggerable polymer can be miscible in the matrix polymer. The triggerable polymer can be derived from a monomer that generates or releases an acid upon activation, a monomer that generates or releases a blowing agent upon activation, or any combination thereof. When triggered (e.g., by heating as discussed in more detail below), the triggerable polymer can generate or release an acid and/or a blowing agent, thereby degrading (e.g., depolymerizing) the matrix polymer.

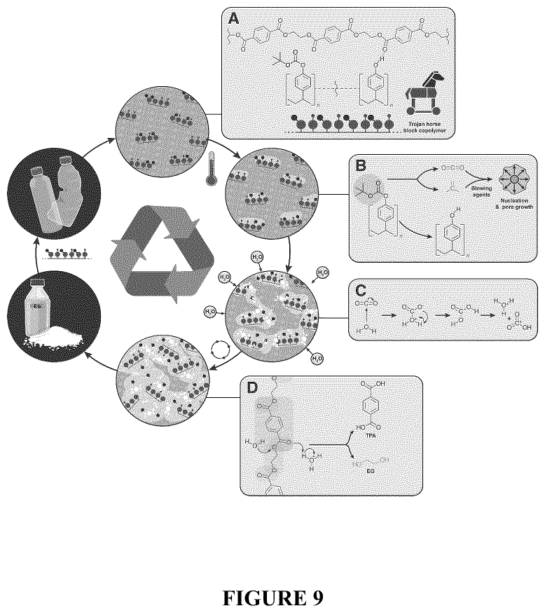

In some embodiments, the matrix polymer comprises a polymer that is susceptible to acid hydrolysis. For example, the matrix polymer can comprise a polyester (e.g., PET), a polyamide (e.g., nylon 6 and/or nylon 66), a polycarbonate, a polysaccharide, a copolymer thereof, or a blend thereof. In these embodiments, when triggered (e.g., by heating) in the presence of water, the triggerable polymer can generate or release an acid and/or a blowing agent. The acid can the catalyze depolymerization of the matrix polymer via acid hydrolysis. The blowing agent can increase surface area of the matrix polymer, further increasing the rate of hydrolysis (and matrix polymer degradation). This process, and the polymer lifecycle afforded by this process, is schematically illustrated (in part) in FIG. 9.

In other embodiments, the matrix polymer comprises a polymer that is not susceptible to acid hydrolysis (e.g., polystyrene or a polyolefin). In these embodiments, when triggered (e.g., by heating), the triggerable polymer can generate or release an acid and/or a blowing agent. The acid and/or blowing agent can mechanically degrade the matrix polymer (e.g., by increasing the surface area and porosity of the matrix polymer), facilitating later degradation/recycling efforts.

Examples of suitable matrix polymers are discussed in more detail below.

In some embodiments, the triggerable polymer comprises a copolymer, such as a block copolymer or a random copolymer. In some embodiments, the triggerable polymer is derived from a monomer that generates or releases the acid upon thermal activation, a monomer that generates or releases the blowing agent upon thermal activation, or any combination thereof.

In some embodiments, the acid comprises carbonic acid (e.g., generated by the release of carbon dioxide in an aqueous solution) or an organic acid, such as acetic acid.

In some embodiments, the blowing agent comprises carbon dioxide.

The triggerable polymer can be present in the polymeric composition in varying amounts. In some embodiments, the triggerable polymer can be present in the polymeric composition in an amount of from 1% by weight to 40% by weight (e.g., from 1% by weight to 35% by weight, from 1% by weight to 30% by weight, from 1% by weight to 25% by weight, from 1% by weight to 20% by weight, from 1% by weight to 15% by weight, from 1% by weight to 10% by weight, from 1% by weight to 5% by weight, from 5% by weight to 40% by weight, from 5% by weight to 35% by weight, from 5% by weight to 30% by weight, from 5% by weight to 25% by weight, from 5% by weight to 20% by weight, from 5% by weight to 15% by weight, from 5% by weight to 10% by weight, from 10% by weight to 40% by weight, from 10% by weight to 35% by weight, from 10% by weight to 30% by weight, from 10% by weight to 25% by weight, from 10% by weight to 20% by weight, from 10% by weight to 15% by weight, from 15% by weight to 40% by weight, from 15% by weight to 35% by weight, from 15% by weight to 30% by weight, from 15% by weight to 25% by weight, from 15% by weight to 20% by weight, from 20% by weight to 40% by weight, from 20% by weight to 35% by weight, from 20% by weight to 30% by weight, from 20% by weight to 25% by weight, from 25% by weight to 40% by weight, from 25% by weight to 35% by weight, from 25% by weight to 30% by weight, from 30% by weight to 40% by weight, from 30% by weight to 35% by weight, or from 30% by weight to 40% by weight), based on the total weight of the polymeric composition.

In certain embodiments, the triggerable polymer can be derived from a monomer that generates or releases the acid and the blowing agent upon thermal activation. For example, the triggerable polymer can be derived from a monomer that generates or releases carbon dioxide. The carbon dioxide can generate carbonic acid in the presence of water while also serving as a blowing agent.

In other embodiments, the triggerable polymer is derived from a first monomer that generates or releases the acid upon thermal activation (e.g., a monomer that releases an organic acid such as acetic acid upon activation) and a second monomer that generates or releases the blowing agent (e.g., carbon dioxide) upon thermal activation.

In some embodiments, the triggerable polymer comprises a polyvinyl phenol backbone functionalized with alkyl carbonate moieties, ester moieties, or a combination thereof. In some examples, the triggerable polymer is derived (as least in part) from a monomer comprising 4-acetoxystyrene.

In some embodiments, the triggerable polymer can comprise a polymer comprising a repeat unit defined by the structure below

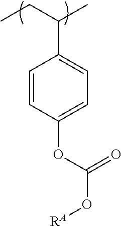

wherein R^{A} is chosen from an alkyl group (e.g., a C1-C12 alkyl group, such as a C1-C6 alkyl group), an alkenyl group (e.g., a C2-C12 alkenyl group, such as a C2-C6 alkenyl group), an alkynyl group (e.g., a C2-C12 alkynyl group, such as a C2-C6 alkynyl group), a cycloalkyl group (e.g., a C3-C12 cycloalkyl group, such as a C3-C6 cycloalkyl group), a heterocycloalkyl group, an aryl group, or a heteroaryl group. In certain embodiments, R^{A} can be an alkyl group (e.g., a C1-C12 alkyl group, such as a C1-C6 alkyl group).

In some examples, the triggerable polymer is derived (as least in part) from a monomer comprising an alkyl-4-vinylphenyl carbonate, such as n-butyl-4-vinylphenyl carbonate, iso-butyl-4-vinylphenyl carbonate, neopentyl-4-vinylphenyl carbonate, or tert-butyl-4-vinylphenyl carbonate.

The matrix polymer can exhibit a glass transition temperature (T_{g}) and a melting temperature (Tₘ). In some embodiments, the monomer exhibits an activation temperature (at which the acid is generated or released and/or the blowing agent is generated or released) of greater than T_{g}, but less than Tₘ. In some embodiments, when the composition is heated to a temperature greater than T_{g}, but less than Tₘ, the monomer generates or releases the acid, the monomer generates or releases the blowing agent, or a combination thereof. In certain embodiments, when the composition is heated to a temperature greater than T_{g}, but less than Tₘ in the presence of water, the matrix polymer undergoes depolymerization.

If desired, the polymeric compositions described herein can further include other additives and components to provide polymeric compositions suitable for particular end uses/applications. Examples of suitable additives, include, but are not limited to, antioxidants, UV stabilizers, anti-ozonants, fillers, plasticizers, crosslinking agents, flame retardants, processing aids, dyes, and colorants.

The polymeric compositions described herein can be used to prepare (in whole or in part) articles of manufacture. Accordingly, also described herein are articles formed, at least in part, from the polymeric compositions described herein. Examples of such articles include, for example, packaging materials (including beverage bottles, consumer product bottles, etc.); containers; disposable/single use items such as flatware, plates, and tablecloths; consumer products; automotive components, medical devices, labeling, clothing, diapers (or components thereof), films, fibers, belts, hoses, tubes, gaskets, membranes, molded goods, extruded parts, adhesives, inner tubes, cushioning articles, polymer sheets, foams, coatings, computer parts, building materials, household appliances, electrical supply housings, lawn furniture strips or webbing, lawn mower, garden hose, refrigerator gaskets, acoustic systems, utility cart parts, desk edging, toys and water craft parts, and the like.

Articles can be prepared from the compositions described herein using suitable conventional methods for manufacturing polymeric articles, including injection molding, extrusion, extrusion followed by either male or female thermoforming, low pressure molding, compression molding, coextrusion, compression molding, lamination, casting, and the like.

Also provided herein are methods for recycling the polymeric compositions and articles described herein. These methods can comprise heating the composition or article to a temperature greater than an activation temperature of the monomer (at which the acid is generated or released and/or the blowing agent is generated or released) in the presence of water. In the cases of compositions and articles in which the matrix polymer comprises a polymer that is susceptible to acid hydrolysis, this can induce depolymerization of the matrix polymer. In some cases, this method can comprise heating the composition or article to a temperature greater than a glass transition temperature (T_{g}) of the matrix polymer but less than a melting temperature (Tₘ) of the matrix polymer.

### Matrix Polymers

The matrix polymer can comprise any suitable polymer for use in preparing articles.

In some embodiments, the matrix polymer can comprise a polymer that is susceptible to acid hydrolysis. In other embodiments, the matrix polymer comprises a polymer that is not susceptible to acid hydrolysis Examples of polymers that may be present in the matrix polymer include, but are not limited to polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral), poly(methyl methacrylate) and other acrylate polymers and copolymers, olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), polycarbonates (PC), polyamides, polyesters, liquid crystalline polymers (LCPs), poly(lactic acid), poly(phenylene oxide) (PPO), PPO-polyamide alloys, polysulphone (PSU), polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting), aramides (such as Kevlar® and Nomex®), polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane), etc.), elastomers, epoxy polymers, polyureas, alkyds, cellulosic polymers (such as ethyl cellulose, ethyl hydroxyethyl cellulose, carboxymethyl cellulose, cellulose acetate, cellulose acetate propionates, and cellulose acetate butyrates), polyethers and glycols such as poly(ethylene oxide)s (also known as poly(ethylene glycol)s, poly(propylene oxide)s (also known as poly(propylene glycol)s, and ethylene oxide/propylene oxide copolymers, acrylic latex polymers, polyester acrylate oligomers and polymers, polyester diol diacrylate polymers, UV-curable resins, etc.

In some cases, the matrix polymer can comprise an elastomer. Examples of elastomers include, but are not limited to, polyurethanes, copolyetheresters, rubbers (including butyl rubbers and natural rubbers), styrene/butadiene copolymers, styrene/ethylene/butadiene/styrene copolymer (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

In some embodiments, the matrix polymer can comprise a polyamide or a copolymer thereof. The term “polyamide” is intended to describe any long-chain polymer having recurring amide groups (—NH—CO—) as an integral part of the polymer chain. Examples of polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, the polyamide of hexamethyleneterephthalamide, and 2-ethylpentamethyleneterephthalamide), etc.

In some cases, the polyamides may be polymers and copolymers (i.e., polyamides having at least two different repeat units) having melting points between about 100 and about 255° C., or between about 120 and about 255° C., or between about 110 and about 255° C. or between about 120 and about 255° C. These include aliphatic copolyamides having a melting point of about 230° C. or less, aliphatic copolyamides having a melting point of about 210° C. or less, aliphatic copolyamides having a melting point of about 200° C. or less, aliphatic copolyamides having a melting point of about 180° C. or less, of about 150° C. or less, of about 130° C. or less, of about 120° C. or less, of about 110° C. or less, etc. Examples of these include those sold under the trade names Macromelt by Henkel, Versamid by Cognis, and Elvamide® by DuPont.

In some embodiments, the matrix polymer can comprise a polyester or a copolymer thereof. The term “polyester” is intended to describe any long-chain polymer having recurring ester groups (—C(O)—O—). Examples of polyesters include aromatic polyesters, such as polyethylene terephthalate (PET), polybutylene terephthalate (PBT), polytrimethylene terephthalate (PTT), poly(ethylene naphthalate) (PEN), and polytriphenylene terephthalate, aliphatic polyesters, such as poly(cyclohexanedimethanol terephthalate) (PCT) and polylactic acid (PLA).

In some examples, the polyester can comprise a terephthalate, a terephthalate glycol, a lactide, a (hydroxy)alkanoate, a copolyesters of terephthalic acid residues, a 2,2,4,4-tetramethyl-1,3-cyclobutanediol, or a 1,4-cyclohexanedimethanol, etc.

Additionally, one can use homopolyesters or copolyesters, such as homopolymers and copolymers of terephthalic acid and isophthalic acid. The linear polyesters may be produced by condensing one or more dicarboxylic acids or a lower alkyl diester thereof, e.g., dimethylterephthalate, terephthalic acid, isophthalic acid, phthalic acid, 2,5-, 2,6-, or 2,7-naphthalene dicarboxylic acid, succinic acid, sebacic acid, adipic acid, azelaic acid, bibenzoic acid and hexahydroterephthalic acid, or bis-p-carboxyphenoxyethane, with one or more glycols, e.g., ethylene glycol, pentyl glycol, and 1,4-cyclohexanedimethanol.

Of these various polyester candidates, because of commercial availability, the terephthalates, such as polyethylene terephthalate (PET) or polybutylene terephthalate (PBT), the lactides, such as polylactic acid (PLA), and the hydroxyalkanoates, such as polyhydroxybutyrate (PHB) or polyhydroxybutyrate-co-valerate (PHBV), are desirable for use. PET is preferred because of its ubiquity and cost, although PLA and PHBV are emerging as bio-derived thermoplastic polyesters which can supplant PET in some situations. In some embodiments, PET may be blended with other polyesters.

In some embodiments, the polyester can comprise polyglycolic acid (PGA), polylactic acid (PLA), poly(lactic-co-glycolic acid) (PLGA), polycaprolactone (PCL), polyhydroxyalkanoate (PHA), polyhydroxybutryate (PHB), polyethylene adipate (PEA), polybutylene succinate (PBS), poly(3-hydroxybutyrate-co-3-hydroxyvalerate) (PHBV), copolymers thereof, or blends thereof.

Examples of suitable polymers include Elvacite® polymers supplied by Lucite International, Inc., including Elvacite® 2009, 2010, 2013, 2014, 2016, 2028, 2042, 2045, 2046, 2550, 2552, 2614, 2669, 2697, 2776, 2823, 2895, 2927, 3001, 3003, 3004, 4018, 4021, 4026, 4028, 4044, 4059, 4400, 4075, 4060, 4102, etc. Other polymer families include Bynel® polymers (such as Bynel® 2022 supplied by DuPont) and Joncryl® polymers (such as Joncryl® 678 and 682).

By way of non-limiting illustration, examples of certain embodiments of the present disclosure are given below.

### EXAMPLES

### Example 1. Design of Self-Recyclable Polyamides Via Embedding with Thermolabile Block Copolymers

Described herein are “self-recyclable” polymer composites that include a first polymer susceptible to cleavage via acid hydrolysis (e.g., a polyester or a polyamide) and a second (co)polymer (e.g., block copolymer) that facilitates depolymerization of the first polymer under controlled triggering conditions.

Towards this end, we have developed functionalized block copolymers designed to thermally decompose and release both an acid catalyst and a blowing agent. This will trigger the hydrolytic depolymerization of polymers such as polyesters and polyesters upon contact with water at controlled temperatures. Herein, we focus on the design of a compatible block copolymer functionalized with alkyl carbonate and acetyl ester groups, and describe its incorporation into polyamide 6 (P6) to create a new class of “self-recyclable” polyamides.

Summary of Approach: To illustrate design of “self-recyclable” polymeric compositions described herein, we propose a “self-recyclable” polymer composite including a blend of a thermolabile block copolymer additive and a polyamide (P6). This composite can possess the desired thermomechanical properties of base polyamide component, while the thermolabile block copolymer can trigger P6 hydrolysis above specific temperatures in the presence of water.

The block copolymer will be miscible in P6 and designed to be thermally decomposed into blowing agents (e.g., CO₂, light olefins) and acidic compounds (e.g., CO₂, acetic acid). The resulting blowing agents and acidic products will act as porogens and acidic catalysts for hydrolytic depolymerization of waste polyamide into monomers, respectively. The release of porogens enhances surface area for chemical reaction, while improving mass transfer. The P6 monomers resulting from the hydrolytic depolymerization can then be purified and used to produce new “self-recyclable” P6 blends.

The block copolymer can be chemically miscible in P6 and be “asleep” during polymer manufacturing and use. In some embodiments, the block copolymer can be “awakened” (activated) by conditions designed to accelerate the depolymerization of waste P6, which can be tunable by the choice of functional side groups. In some examples, we use polyvinyl phenol (PVP) as block copolymer backbone, which can be decorated with alkyl carbonate and ester groups (Scheme 1). Their miscibility in P6 and thermostability can be evaluated, allowing us to select further block copolymer candidates for developing plastic blends with the desired properties.

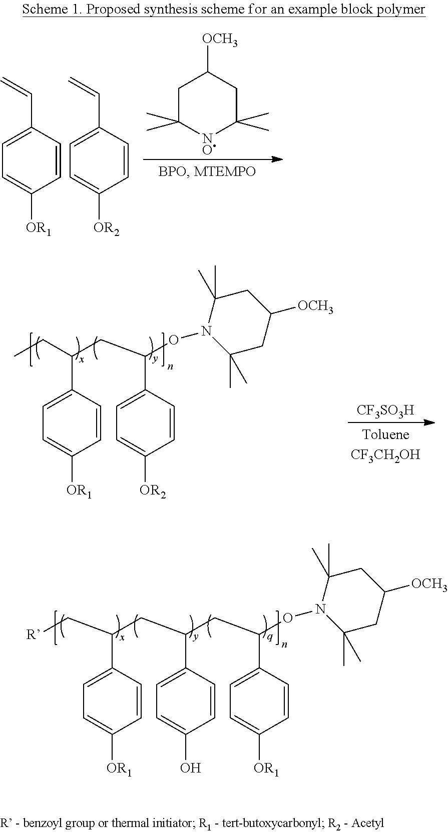

Using this strategy, we will access a new class of polymeric composites comprising a polyamide such as, for example, P6 and a miscible block copolymer which can be thermally decomposed into blowing agents and organic acids at desirable temperatures. The acid generated can then catalyze the hydrolytic depolymerization of P6 into monomers in the presence of water. The thermal decomposition temperature of a successful block copolymer can be between the glass transition temperature (T_{g}) and melting temperature (Tₘ) of P6. The proposed conceptual design of polyamide blends is expected to be more easily recyclable, without the need for sorting and expensive logistical operations, while offering similar thermomechanical properties to that of P6.

The PVP-containing block copolymer with a polyamide (P6) can be present in the blend at appropriate ratios to effectively promote self-depolymerization in the presence of water at defined temperatures. PVP can serve as the main copolymer backbone due to its good miscibility in P6 showing appropriate thermostability for our objective. The PVP backbone can be decorated with thermolabile side groups, such as tert-butyl carbonate and acetyl groups, which degrade into gases and/or acids that promote surface area increase and accelerate polyamide hydrolysis into respective monomers at high temperatures in the presence of water. The local concentration of acid in the formed pores should be higher than in the bulk phase, which should accelerate depolymerization from inside-out, as new surfaces expand within polymer particles.

### Research Approach

Design and Synthesis of the Block Copolymer. Based on the reasonable PVP miscibility with P6, we will pursue the design of block copolymers composed of monomeric units such as, vinyl phenol, 4-acetoxystyrene, and tert-butyl-4-vinylphenyl carbonate. We will synthesize triblock copolymers with varying ratios of the three types of monomers (Scheme 1).

Once a library of example block copolymers are produced, miscibility in P6 will be determined and thermostability studies will be conducted for each of the copolymers. A statistical method will be used to optimize the block co-polymer composition that maximizes its miscibility in P6, while presenting appropriate thermostability properties for the proposed goal

Optimize blends of block copolymer and P6. Blends of a selected block copolymer and P6, of varying compositional ratios, will be produced and characterized for their thermochemical and mechanical properties. The results will be compared with the pristine P6 to evaluate deviations in thermomechanical performance.

Optimize the hydrolytic self-depolymerization of copolymer/P6 blends. For the most promising block copolymer/P6 blends, we will evaluate their self-hydrolytic depolymerization ability in the presence of water at varying conditions of temperature and reaction time. The performance of each P6-based blend will be evaluated based on monomeric ε-caprolactam yield and P6 conversion. Finally, we will expand upon this proof-of-concept study to understand how copolymer design impacts the thermomechanical properties of P6 blends and the fundamental mechanisms driving the hydrolytic depolymerization for the proposed system.

This work will bridge technological gaps between the current polyamide design, which are poorly recyclable, and future “self-recyclable” polyamides designed to simplify their circularity. This will support a new paradigm shift in the manufacturing of plastics and simplify the implementation of a circular economy for waste plastics, which would also benefit the sustainability of products

### Example 2. Investigation of Example Self-Recyclable Polyester Composites

### Materials and Methods

Anhydrous pyridine (99.8%, #CAS 110-89-1), tetrahydrofuran (THF) (ACS grade, #CAS 109-99-9), formic acid (FA) (99% purity, #CAS 64-18-6), acetonitrile (CH₃CN) (HPLC grade, #CAS 75-05-8), anhydrous sodium sulfate (NaSO₄) (99%, #CAS 7757-82-6), dihydrolevoglucosenone (Cyrene) (ACS grade, #CAS 53716-82-8), butyl chloroformate (99%, #CAS 592-94-7), neopentyl chloroformate (97%, #CAS 20412-38-8), hydrochloric acid (HCl) (ACS reagent, 37%) (#CAS 7647-01-0), chloroform-d (D, 99.8%, #CAS 865-49-6), bis(2-hydroxyethyl) terephthalate (BHET) (94.5% #CAS 959-26-2), poly (4-vinyl phenol) (avg. mol. wt. 25000, #CAS 24979-70-2), were purchased from Sigma-Aldrich (St. Louis, MO, USA). Terephthalic acid (99% purity #CAS 100-21-0), ethyl acetate (HPLC grade, #CAS 141-78-6), dimethyl sulfoxide (DMSO) (HPLC grade, #CAS 67-68-5) and acetone (HPLC grade, #CAS 67-64-1), were purchased from ACROS Organics (Thermo Fisher Scientific, Waltham, MA, USA). Semicrystalline powder PET (product code: ES30-GL-000115) and granular semicrystalline PET (3-5 mm, product code: ES30-GL-000115) were purchased from Goodfellow Corporation (Pittsburgh, PA, USA). Mono (2-hydroxyethyl) terephthalate (MHET) (95% purity, #CAS 1137-99-1) was purchased from AmBeed (Arlington Heights, USA). Sec-butyl chloroformate (95%, #CAS 17462-58-7) was purchased from AK Scientific (Union City, CA, USA). The UHP nitrogen (N₂) (99.999%) was procured from Matheson (Irving, TX, USA). Acetone-d6 (D, 99.9%, #CAS 666-52-4) and trifluoroacetic acid-d (D, 99.5%, #CAS 599-00-8) were purchased from Cambridge Isotope Laboratories, Inc. (Andover, MA, USA). All the chemicals were used as received.

### Characterization

The X-ray diffraction (XRD) patterns of functionalized PVP-PET composite films were measured using a Bruker D2 Phaser instrument equipped with Lynxeye detector (Billerica, MA, USA) with Co-Kα (1.79026 Å). The source current and voltage were set to 10 mA and 30 kV. All the samples are measured from 20 of 5-60° at the step size of 0.2 s with an increment of 0.02°. All the XRD patterns are converted from Co-Kα (1.79026 Å) to Cu-Kα (1.5406 Å) using the following Equation 1.

$$2 θ value for Cu K α = 114.591 \; 56 \times Asin ( \frac{Cu K α 1.5406}{Co K α 1.79026} ) \times Sin ( 0.00872664 \times 2 θ value obtained from Co K α ) ) \qquad ( Equation 1 )$$

Thermal behaviors such as stability and melting temperatures for pristine powder PET, pristine PVP, functionalized PVP, PVP-PET composites, and functionalized PVP-PET composite films were measured using TA instruments SDT 650 model (New Castle, DE, USA). Approximately 10 mg of sample was loaded on an aluminum crucible and heated from 25-700° C. with heating rate of 5° C.·min⁻¹ in the presence of nitrogen (50 mL·min-1). The crystallinity was measured by heat flow·g⁻¹ from 25 to 300° C., DSC heat flow curves obtained from the same instrument with covered lids and an empty aluminum crucible was used as a reference. The percentage of crystallinity was calculated from heat of melting (ΔHₘ), cold crystallization (ΔH_{cc}), and reference heat of melting (ΔH⁰ₘ) for 100% crystalline PET is 140.1 J·g⁻¹ using Equation 2.

$$Crystallinity ( \% ) = \frac{Δ {H}_{m} - Δ {H}_{c c}}{Δ {H}_{m}^{0}} \times 100 \qquad ( Equation 2 )$$

The Attenuated total reflectance (ATR)—Fourier Transform Infrared Spectroscopy (FTIR) patterns of pristine powder PET, pristine PVP, functionalized PVP, PVP-PET composites and functionalized PVP-PET composite films were measured using Shimadzu IRSpirit (QATR-S) from 500-4000 cm⁻¹ with a resolution of 4 cm⁻¹ and 64 scans. All ¹³C and ¹H Nuclear magnetic resonance (NMR) spectra were obtained in acetone-d6/chloroforam-d, with a 500 Hz instrument. ¹³C spectra were measured with a proton-decoupling pulse sequence. All chemical shifts (ppm) were calibrated to the residual peak of the deuterated solvents (¹H (CD₃COCD₃) δ=2.05 ppm, p; ¹³C (CD₃COCD₃) δ=206.26 ppm; ¹H (CDCl₃) δ=7.26 ppm, s; ¹³C (CDCl₃) δ=77.16 ppm). Coupling constants (J) are expressed in Hertz (Hz).

### Synthesis

Functionalization of PVP with alkyl chloroformate. Unless otherwise noted, all reactions were carried out under atmospheric pressure using a neck round bottom flask in a chemical fume hood. All glassware used was dried at 100° C. in an oven prior to use. All organic extracts were dried over anhydrous sodium sulfate (NaSO₄), further, solvents were removed under reduced pressure using a rotary evaporator (Yamato, RE202-A Rotary Evaporator). The overall reaction scheme is illustrated in Scheme 2 below.

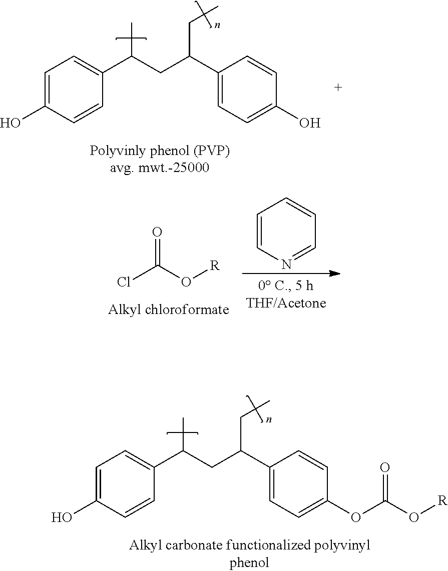

Poly (4-vinyl phenol) (PVP avg. mol. wt. 25000, 5.0 g), alkyl chloroformate (1.0 g) and THF (120 mL) were added to a 500 mL RB flask and stirred for 30 min at 0° C. in an ice bath. Anhydrous pyridine (12.6 mmol, 1.0 g) was added drop-wise over 5 min at 0° C. to this reaction mixture. Yellowish precipitate was formed with the addition of anhydrous pyridine. The reaction contents were stirred for 5 h at 0° C.; as the reaction proceeded, the yellowish precipitation slowly diminished After 5 h, the contents are allowed to reach room temperature, and the solvent was removed by rotary evaporation (40° C. bath temperature). The obtained solid was dissolved in ethyl acetate, and the organic layer was washed three times with 100 mL of 1 M HCl solution and three times with 500 mL of cold DI water. The obtained ethyl acetate was dried over NaSO₄ and filtered, followed by solvent removal via rotary evaporation (40° C. bath temperature). The obtained functionalized PVP polymer was stored for further application and named as butyl carbonate-PVP (BCPVP, P1), isobutyl carbonate-PVP (IBCPVP, P2), and neopentyl carbonate-PVP (NCPVP, P3).

Butyl carbonate-PVP. ¹H NMR (500 MHz, Acetone) δ 8.00 (s, 6H), 7.13-6.19 (m, 28H), 4.23 (s, 2H), 3.39 (s, 2H), 1.70 (s, 2H), 0.95 (s, 1H). ¹³C NMR (126 MHz, Acetone) δ 155.46, 153.98, 149.60, 137.07, 129.06 (d, J=53.6 Hz), 120.88, 115.22, 68.49, 30.87, 19.11, 13.53, 39.97 (d, J=43.6 Hz).

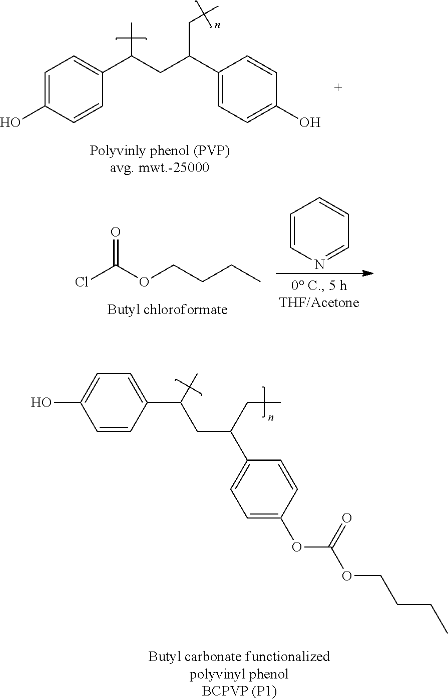

Isobutyl carbonate-PVP. ¹H NMR (500 MHz, Acetone) δ 7.97 (s, 29H), 7.10-6.24 (m, 112H), 4.76 (s, 2H), 3.01 (s, 8H), 0.96 (d, J=7.2 Hz, 8H). ¹³C NMR (126 MHz, Acetone) δ 155.97, 137.60, 129.63 (d, J=50.0 Hz), 115.72, 77.92, 40.42, 19.62, 9.93.

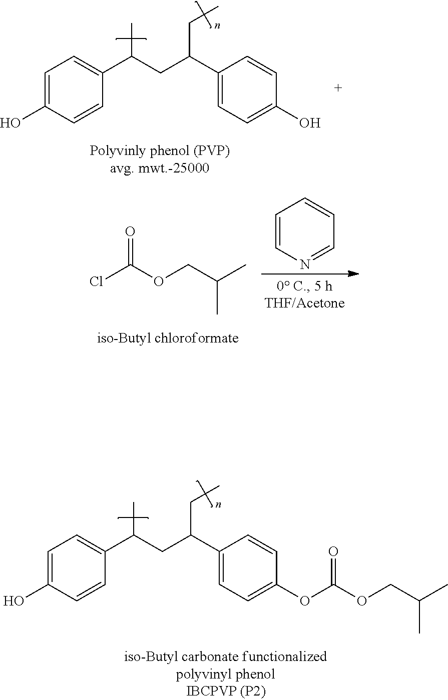

Neopentyl carbonate-PVP. ¹H NMR (500 MHz, Acetone) δ 8.08 (s, 1H), 7.14-6.15 (m, 1H), 3.94 (d, J=10.7 Hz, OH), 3.03 (s, 1H), 0.99 (d, J=6.1 Hz, 2H). ¹³C NMR (126 MHz, Acetone) δ 155.92, 154.54, 137.51, 129.36, 121.33, 115.66, 78.22, 40.30, 32.10, 26.49.

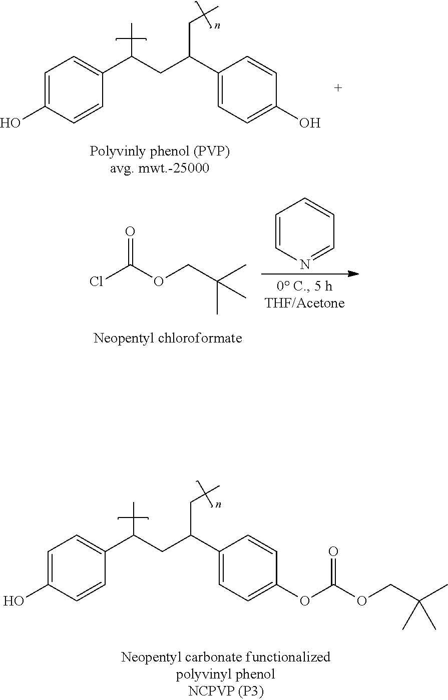

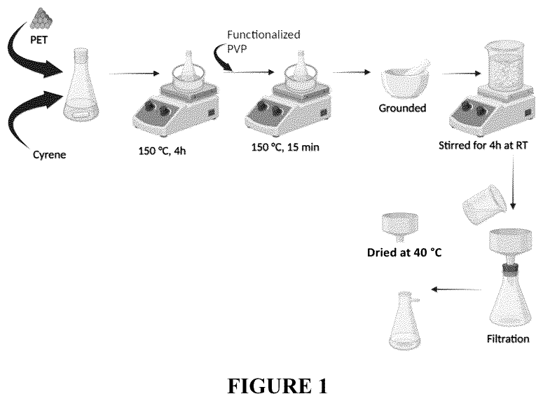

Synthesis of PVP-PET and Functionalized PVP-PET Composites. To prepare 10 g of 10 wt. % PVP-PET polymer composite (FIG. 1), the required amount of PET (9.0 g) was added to 250 mL of conical flask, followed by the addition of 50 mL of solvent and closed with rubber septum. The conical flask is placed in a preheated oil bath (150° C.) placed over hotplate (VWR® magnetic hotplate stirrer) while stirring at 200 RPM. This step ensures the complete dissolution of PET in Cyrene in 1 h. To the obtained dissolved PET solution, a measured amount of PVP (1 g) was added. The contents were further stirred for 15 min to obtain a soluble mixture of PVP-PET and allowed to cool to RT. The obtained solid was grounded using motor-piston, and the contents were transferred to 3.5 L beaker with subsequent DI water. This further allowed stirring for 4 h with 3 L of DI water and filtered using Buchner funnel (Catalog No. FB966F) and Whatman filter paper (Catalog No. 1001-110). Finally, the solids were dried in a vacuum oven at 40° C. for 48 h. The recrystallized 10 wt. % PVP-PET composite named as 10PVP-PET-R (P4), “R” stands for recrystallization. In a similar fashion, 20 and 30 wt. % PVP-PET, and 10 wt. % functionalized PVP-PET composites were prepared, and they were named as, 20PVP-PET-R (P5), 30PVP-PET-R (P6), 10BCPVP-PET-R (P7), 10IBCPVP-PET-R (P8), 10NCPVP-PET-R (P9). Similarly, 100% PET was recrystallized using Cyrene and used as a control and named as PET-R (P10).

Preparation of Films. All the films were prepared using a heated Hydraulic press. In a typical preparation, the sample was placed and evenly distributed in 6×12 cm space with thickness of 0.8 mm in between Kapton polyimide film (Item number—2271K912) supported by a stainless-steel plate on both sides. All together were placed in between hot press plates, and the plates were heated to 200° C. at 5-ton clamp force for 1 h. At this condition, the SS plate acquired a temperature of 70° C. After 1 h, the heating was stopped, and force was released for the hot press plates. As the temperature of SS plates reached room temperature, the films obtained were collected and used for further characterization and testing. The sample coding was similar to composites code and addressed as film with code (F), 10BCPVP-PET-F (P11), 10IBCPVP-PET-F (P12), 10NCPVP-PET-F (P13), and PET-F (P14).

Sieving. The films were made into small sizes to obtain a uniform size between 2.0 mm and 1.7 mm by combining two different sieves (USA Standard Testing Sieve, ASTM E-11 specification, No 10 and 12). The obtained uniform size between 2.0 and 1.7 mm was further used for hydrolysis studies.

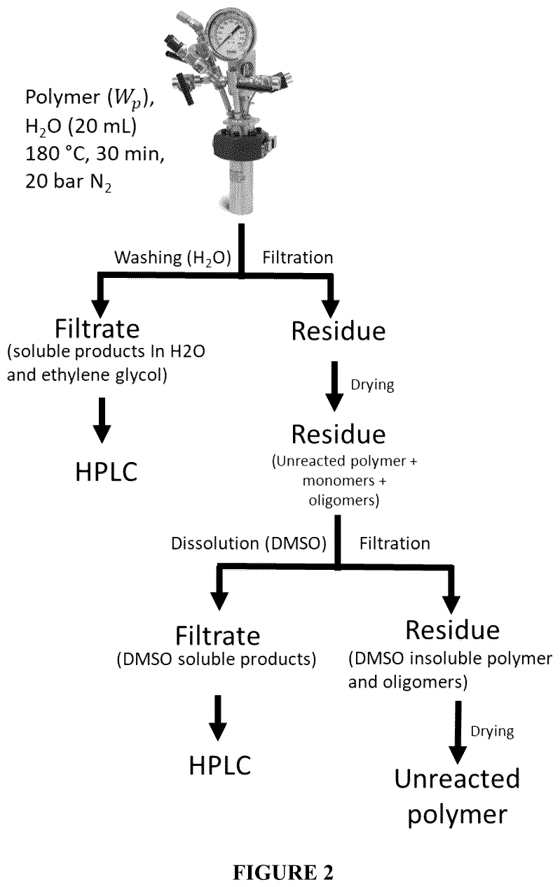

Hydrolysis of PVP-PET composites. The catalytic hydrolysis of PET and functionalized PVP-PET composite films is schematically illustrated in FIG. 2. The catalytic hydrolysis of PET and functionalized PVP-PET composite films was performed using a 100 mL Series 4590 micro stirred autoclave from Parr Instrument Company (Moline, IL, USA) equipped with a J-type thermocouple, heating jacket, and pressure transducer. The autoclave vessel was charged with 2.0 g of substrate and 20 mL of DI water and sealed. Initially, the autoclave was flushed three times with 20 bar N₂ and further pressurized to 20 bar with N₂ at room temperature (˜22° C.). The reaction temperature was set to 180° C. with a fast-heating rate of ˜10° C.·min⁻¹, 500 RPM, and held for 30 min. After 30 min, the reaction was quenched in an ice-water bath until room temperature was achieved, and the autoclave was depressurized. The workup procedure after reaction was shown in Scheme 6. The reaction contents were collected using additional DI water to wash and rinse the reactor and further filtered using Whatman filter paper (Catalog No. 1001-110). The filtrate obtained was measured and further diluted to 1 mL in 25 mL of DMSO, and filtered using 0.2 μm syringe filter, and further analyzed for any water-soluble products using high-performance liquid chromatography (HPLC). The residue was dried in a vacuum drying oven at 40° C. (Yamato, ADP300C) for 48 h. The dried residue was dissolved in 50 mL of DMSO and filtered using Whatman filter paper (Catalog No. 1001-110). This step ensured that all the TPA, MHET and BHET formed during hydrolysis were dissolved before further analysis. The filtrate was diluted (1 mL in 25 mL of DMSO) and filtered using a 0.2 μm syringe filter before being injected into HPLC for analysis (described below).

Product Characterization. The post reaction samples were analyzed using an HPLC equipped with an Phenomenex Luna® 5 μm C18(2) (100 Å, 150×4.6 mm, Part #OOF-4252-EO) column at 40° C. with 1 wt. % formic acid (FA) and acetonitrile (CH₃CN) gradient flow at 240 nm using UV detector. The gradient flow starts from 99% FA and 1% CH₃CN and finished at 60% FA and 40% CH₃CN in 40 min. The maximum theoretical yield of MHET, BHET and TPA was calculated using external calibration curves by measuring the response of the respective standard compound of known concentration. The theoretical yield of products in the loaded PET was calculated by considering the molecular weight fraction of MHET, BHET and TPA within the PET monomer unit (C₁₀H₈O₄), which has molecular weights of 210.2, 254.2 and 166.13 g-mol⁻¹, respectively. The formulas below were used to calculate the yield of each product

$$MET yield = \frac{Mass of MET obtained from HPLC}{Theoretical mass yield of MET from PET} \times 100 \% \qquad ( Equation 3 )$$

$$BHET yield = \frac{Mass of BHET obtained from HPLC}{Theorecical mass yield of BHET from PET} \times 100 \% \qquad ( Equation 4 )$$

$$TPA yield = \frac{Mass of TPA obtained from HPLC}{Theoretical mass yield of TPA from PET} \times 100 \% \qquad ( Equation 5 )$$

### Results and Discussion

Characterization of functionalized PVP. Primarily, alkyl carbonated PVP was characterized and studied using NMR, FTIR and TGA. The functionalization of the PVP was identified using ¹H and ¹³C NMR studies. The ¹H and ¹³C NMR of functionalized PVP polymer with butyl chloroformate, iso-butyl chloroformate and neopentyl chloroformate shows the presence of carbonate functional group.

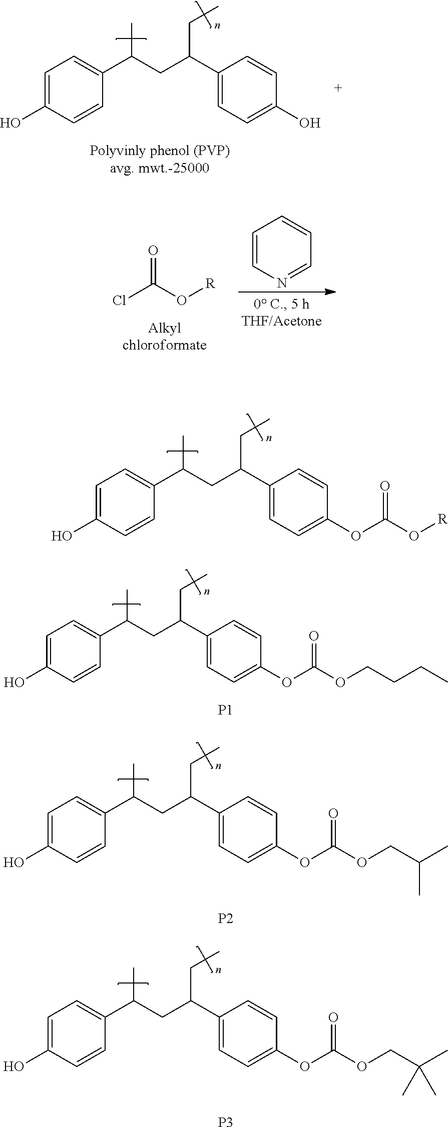

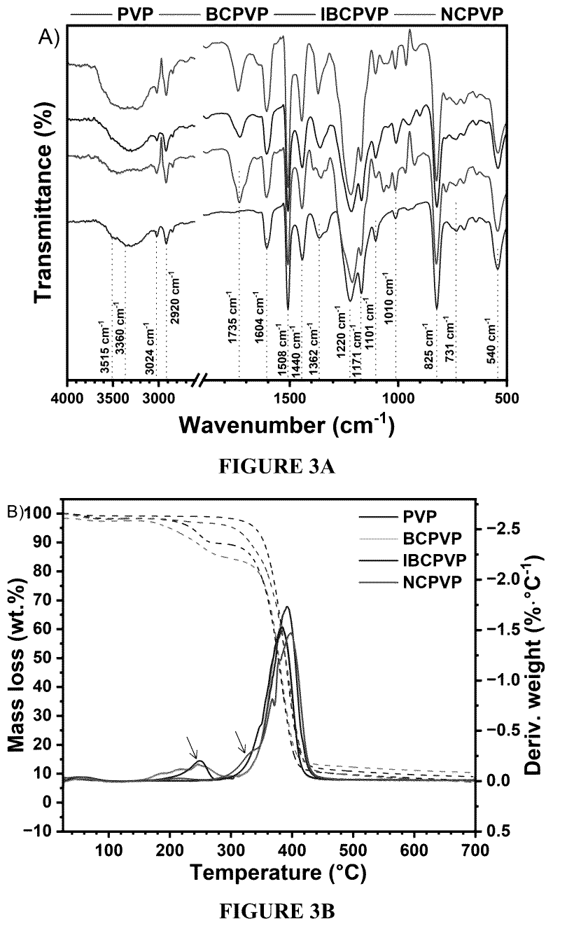

Further FTIR studies were performed to understand the structural properties of functionalized PVP with comparison to pristine PVP (FIG. 3A). The FTIR spectra for all the butyl carbonate isomer functionalized PVP show the presence of 1735 cm⁻¹ signal, which is assigned to the C═O stretching frequency of carbonate functional group present. This signal corresponds to C═O was absent in pristine PVP, this clearly indicates that butyl carbonate isomers were structurally integrated with PVP after functionalization. Similarly, the presence of inter and intra hydrogen bonding of hydroxyl group of phenol (0-H stretch, 3360 cm⁻¹) appeared at lower wavenumber. The non-hydrogen-bonded hydroxyls or free O—H hydroxyl stretch was observed at 3515 cm⁻¹. These finds show the anchoring of isomers of butyl chloroformate to PVP polymer with formation of carbonate and free hydroxyl groups. Similarly, the other peaks corresponding to aromatic ring C═C out-of-plane bend (540 cm⁻¹), ring C—H out-of-plan bending (731 cm⁻¹), aromatic ring C═C stretching or —CH₂ rocking (825 cm⁻¹), ring C—H in-plane bending (1010 cm⁻¹), C—O stretching (1101 cm⁻¹), aromatic-1, 4 substituted ring or ring C—H in-plane bending (1171 cm⁻¹), ring-methyl C—C stretching (1220 cm⁻¹), C—H in-plane bending of alkyl (1325 and 1362 cm⁻¹), —CH₂ bending (1440 cm⁻¹), aromatic ring C═C stretching (1508, 1604 cm⁻¹), aliphatic methyl and methylene groups stretching (—CH₃, —CH₂; 2920, 3024 cm⁻¹). The FTIR studies confirms the presence of alkyl carbonate isomers that are chemically integrated with the PVP structure

The TGA was performed to study functionalized PVP's thermal stability and decomposition in nitrogen atmosphere (FIG. 3B). The mean decomposition temperature of PVP was observed at ˜390° C. While the carbonate functional groups of functionalized PVP were decomposed below PVP decomposition temperature. The BCPVP shows the wide range of decomposition temperatures from 160 to 290° C. and the maximum weight loss was observed at 250° C. Similarly, the IBCPVP exhibited decomposition in between 200-270° C. with a mean temperature around 250° C. Meanwhile, the NCPVP shows decomposition temperature from 280-340° C. with mean temperature of 318° C. These results indicate that the carbonate functionalized PVP is thermally stable at least up to 160, 200 and 280° C. in presence of n-butyl, isobutyl and neopentyl carbonate functional groups, respectively. The thermal stability of butyl carbonate isomer with PVP was increased as BCPVP<IBCPVP<NCPVP.

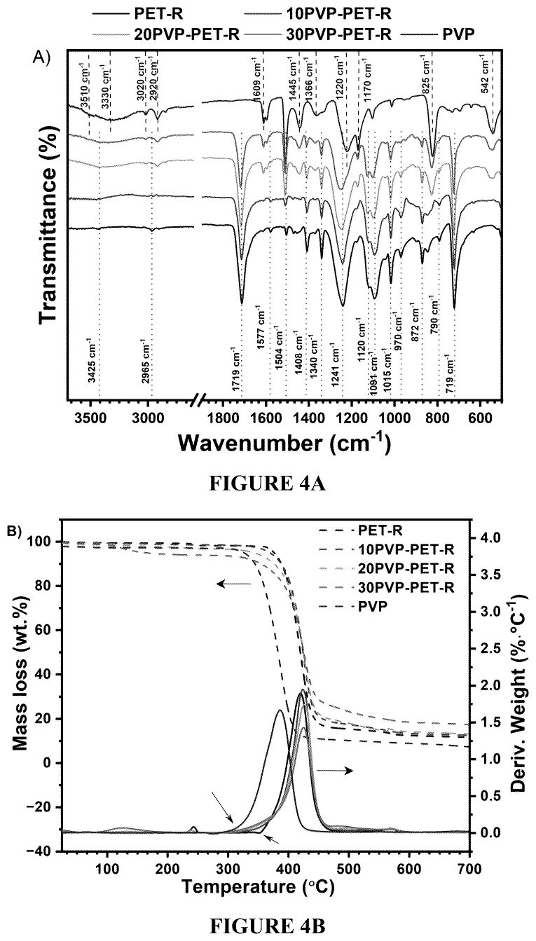

Characterization of PVP-PET Composite Blends. The different wt. % loaded PVP-PET composites were prepared and studied to optimize the loading of PVP on PET. Structural interaction and thermal stability were studied using FTIR and TGA and compared with pristine PVP and PET. The ATR-FTIR spectra were recorded to study the interactions of PVP and PET in the different wt. % PVP-PET composites blends. The vibrations corresponding to PET was identified and assigned to different functional groups (FIG. 4A), likewise aromatic ring C—H out-of-plan bending (719 cm⁻¹), aromatic ring C—H out-of-plan bending or CCO bending (790 cm⁻¹), aromatic ring C—H out-of-plane bending or aromatic ring-ester C—C out-of-plane bending (872 cm⁻¹), O—CH₂ stretching (970 cm⁻¹), aromatic ring C—H in-plane stretching (1015 cm⁻¹), C—O stretching (1091 cm⁻¹), aromatic ring C—H bending in-plane or aromatic ring C—C stretching (1120 cm⁻¹), C(═O)—O stretching or aromatic ring-ester C—C stretching (1241 cm⁻¹), C—H in-plane bending of alkyl (1340 cm⁻¹), aromatic skeleton stretching (1408 cm⁻¹), —CH₂ bending (1453 cm⁻¹ and 1470 cm⁻¹), aromatic ring C═C stretching (1504 cm⁻¹ and 1577 cm⁻¹), carbonyl C═O stretching (1711 cm⁻¹), —CH₂ symmetrical stretching (2964 cm⁻¹), and free hydroxyl —OH stretching (3425 cm⁻¹).

In the PVP-PET composite blends, the presence of PVP was up to 10 wt. % shows the characteristic vibrations of PET. As the PVP loading increased above 10 wt. % the intensity of the characteristic vibrations correspond to C═C out-of-plane bend (542 cm⁻¹), aromatic ring C═C stretching or —CH₂ rocking (825 cm⁻¹), aromatic-1, 4 substituted ring or ring C—H in-plane bending (1170 cm⁻¹), aromatic ring C═C stretching (1508, 1609 cm⁻¹), C—H in-plane bending of alkyl (1366 cm⁻¹), and —CH₂ bending (1445 cm⁻¹) of PVP increased. The vibrations for C(═O)—O stretching, or aromatic ring-ester C—C stretching shifted to lower wavenumber from 1241 to 1220 cm⁻¹ and —CH₂ symmetrical stretching shifted to higher wavenumber from 2965 to 3020 cm⁻¹ for 30 wt. % of PVP loaded PET. In addition, vibrations correspond to hydrogen bonded hydroxyl group of phenol O—H stretch and free phenol O—H hydroxyl stretch appeared at 3330 cm⁻¹ and 3510 cm⁻¹ for 30 wt. % of PVP loaded PET. These changes in the vibrations were absent in 10 wt. % PVP loaded PET. These facts show that the blending more than 10 wt. % of PVP to PET loses the characteristic nature of PET.

Further, the decomposition temperature and thermal stability studies of PVP-PET composites were performed in nitrogen atmosphere (FIG. 4B). The mean decomposition temperature of pristine PVP and PET was observed at 385 and 420° C. The different wt. % PVP-PET composites have similar mean decomposition temperatures to pristine PET around ˜425° C. The decomposition of PVP starts above 285° C. This was slightly shifted to higher temperature when PVP is blended with PET for PVP-PET composites. The starting temperature for the PVP-PET composites is around 320° C. These results show that the PVP-PET composites are thermally stable at least up to 320° C. in nitrogen atmosphere compared to pristine PET. The above observations indicate that the 10 wt. % PVP loading would be ideal for these composite blends. Further studies were conducted by loading 10 wt. % of functional PVP on PET.

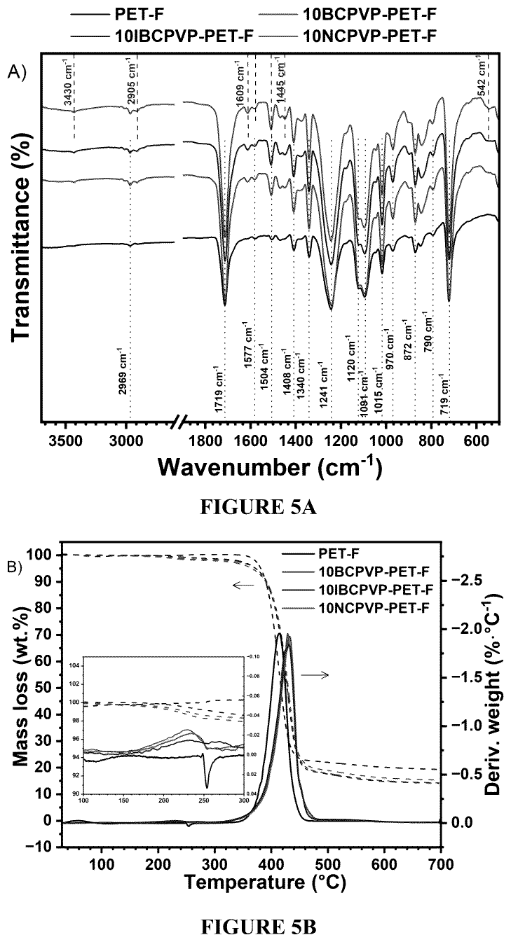

Characterization alkyl carbonated PVP-PET composite films. From the 10 wt. % PVP loading optimization studies, 10 wt. % of alkyl functional PVP was loaded on PET by using similar procedure mentioned above. The functional PVP-PET composite films were prepared by the procedure detailed above. Further, these films were studied for structural changes using ATR-FTIR. All alkyl functional PVP loaded PET films exhibited the characteristic vibrations of PET with noticeable changes in the intensity of the vibration bands. Those vibrations correspond to C═C out-of-plane bend (542 cm⁻¹), —CH₂ bending (1445 cm⁻¹), aromatic ring C═C stretching (1508, 1577, 1609 cm⁻¹), —CH₃ and —CH₂ symmetrical stretching (2905 and 2969 cm⁻¹), and free hydroxyl —OH stretching (3430 cm⁻¹) groups (FIG. 5A). These vibrations are of high intensity compared to the PET film. However, the identification of the alkyl carbonate functional groups was unsuccessful from FTIR studies. As the 1.6 wt. % of alkyl carbonate is present in the total PVP-PET composite film, further confirmation was made using TGA mass loss. The mass loss curves for PET film and functional PVP-PET films look almost similar, however, functionalized PVP-PET composite films exhibited little weight loss of 2% at 200° C. with Tₘₐₓ 230 C observed from DTA (FIGS. 5B and 5B insert). This could be the starting point for the evidence of alkyl carbonate functional groups still present after film preparation

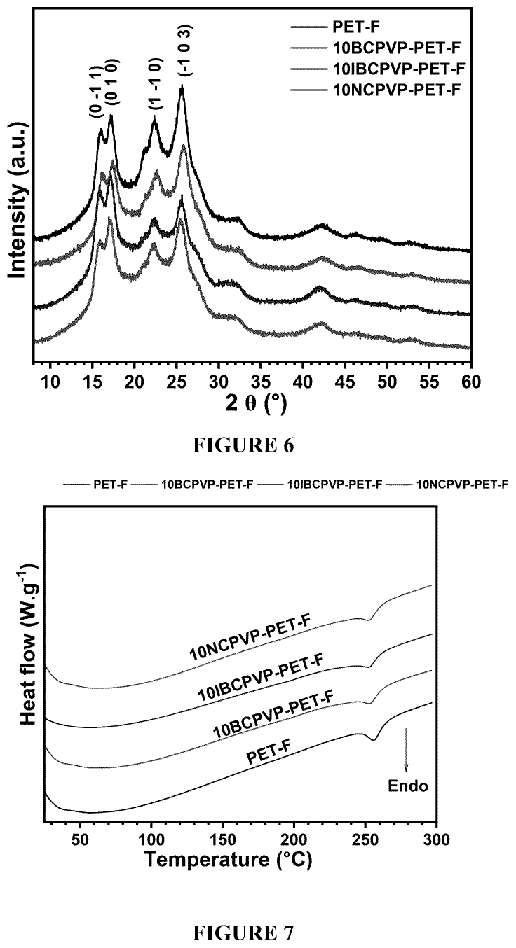

After confirmation of successful loading of alkyl carbonate functional PVP on PET, the existing copolymer (PVP and PET blends) was further studied using XRD and DSC. The crystalline structure of copolymer, and PET-F were studied and compared to the pristine powder PET (FIG. 6). For PET-F, the XRD patterns show crystalline characteristic diffractions at 2θ 16.3, 17.6, 22.7, and 26.1° correspond to (0-11), (010), (1-10), and (−103) plans, respectively, of the triclinic cell of a crystalline PET. A broad peak from 12 to 30° indicates the amorphous nature of PET, which overlaps with crystalline peaks due to its semicrystalline nature, which is in line with pristine powder PET.

For all copolymer (functionalized PVP-PET composite) films, a similar diffraction pattern of PET-F was observed, indicating that the semicrystalline nature of PET was retained after functionalized PVP addition and no significant changes in the crystalline content of PET were observed. An attempt was made to measure the crystalline index from XRD (Table 1), which shows 60 to 70% highly crystalline region of the polymers. As the crystalline index is the ratio of area under crystalline diffraction and total diffraction (crystalline and amorphous).

TABLE 1
Crystalline content in pristine powder PET and
PET film after recrystallization and functional
PVP loaded PET film after recrystallization.

| | Crystallinity | Degree of | Absorbance ratio |
|---|---|---|---|
| | index | crystallinity | from FTIR |
| Sample | from XRD (%) | from DSC (%) | A1341/A1410 |
| Powder PET | — | 40.2 | — |
| PET-F | 68.4 | 27.2 | 1.34 |
| 10BCPVP-PET-F | 68.5 | 28.5 | 1.49 |
| 10IBCPVP-PET-F | 64.5 | 30.2 | 1.47 |
| 10NCPVP-PET-F | 61.7 | 29.2 | 1.48 |

Further the present crystallinity of composites was quantified using DSC measurements. The heat flow curves show the endothermic melting peak of PET at around 250° C. (FIG. 7), no cold crystallization peak was found, and the percentage of crystallinity was given in Table 1. The crystallinity of PET film and PVP-PET composites films are almost similar around ˜30%, however little decrease from the pristine powder PET.

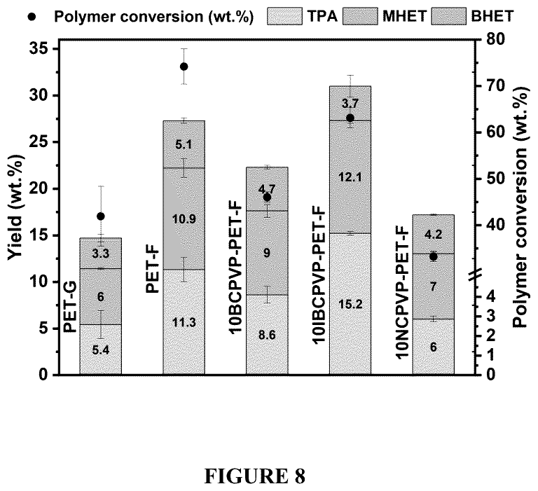

Catalytic hydrolysis of functionalized PVP-PET composites films. Self-recyclable properties of functionalized PVP-PET composites polyester polymers were tested under hydrolysis and the results are compared with the pristine granular PET and PET-F. See FIG. 8. Very low polymer conversion was observed for P13 and PET-G, and the monomer recovery is superior for the 10NCPVP-PET-F. On the other hand, PET-F resulted in high conversion of polymer, but the monomer recovery is lower than 10IBCPVP-PET-F. Overall the monomer recovery and conversion is better with 10IBCPVP-PET-F composite polyester polymers.

The compositions, systems, and methods of the appended claims are not limited in scope by the specific compositions, systems, and methods described herein, which are intended as illustrations of a few aspects of the claims. Any compositions, systems, and methods that are functionally equivalent are intended to fall within the scope of the claims. Various modifications of the compositions, systems, and methods in addition to those shown and described herein are intended to fall within the scope of the appended claims. Further, while only certain representative compositions, systems, and method steps disclosed herein are specifically described, other combinations of the compositions, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A polymeric composition comprising a blend of:
a matrix polymer and a triggerable polymer; and
wherein the triggerable polymer is derived from a monomer that generates or releases an acid upon activation, a monomer that generates or releases a blowing agent upon activation, or any combination thereof.

2. The composition of claim 1, wherein the matrix polymer comprises a polymer that is susceptible to acid hydrolysis.

3. The composition of claim 1, wherein the matrix polymer comprises a polyester, a polyamide, a polycarbonate, a copolymer thereof, or blend thereof.

4. The composition of claim 1, wherein the matrix polymer comprises a polyester, such as PET.

5. The composition of claim 1, wherein the matrix polymer comprises a polyamide, such as nylon 6 and/or nylon 66.

6. The composition of claim 1, wherein the triggerable polymer comprises a copolymer, such as a block copolymer or a random copolymer.

7. The composition of claim 1, wherein the triggerable polymer is derived from a monomer that generates or releases the acid upon thermal activation, a monomer that generates or releases the blowing agent upon thermal activation, or any combination thereof.

8. The composition of claim 1, wherein the triggerable polymer is derived from a monomer that generates or releases the acid and the blowing agent upon thermal activation.

9. The composition of claim 1, wherein the triggerable polymer is derived from a first monomer that generates or releases the acid upon thermal activation and a second monomer that generates or releases the blowing agent upon thermal activation.

10. The composition of claim 1, wherein the triggerable polymer comprises a polyvinyl phenol backbone functionalized with alkyl carbonate moieties, ester moieties, or a combination thereof.

11. The composition of claim 1, wherein the triggerable polymer is derived from a monomer comprising 4-acetoxystyrene.

12. The composition of claim 1, wherein the triggerable polymer is derived from a monomer comprising an alkyl-4-vinylphenyl carbonate, such as n-butyl-4-vinylphenyl carbonate, iso-butyl-4-vinylphenyl carbonate, neopentyl-4-vinylphenyl carbonate, or tert-butyl-4-vinylphenyl carbonate.

13. The composition of claim 1, wherein the acid comprises carbonic acid or an organic acid, such as acetic acid.

14. The composition of claim 1, wherein the blowing agent comprises carbon dioxide.

15. The composition of claim 1, wherein the triggerable polymer is miscible in the matrix polymer.

16. The composition of claim 1, wherein the matrix polymer exhibits a glass transition temperature (T_{g}) and a melting temperature (Tₘ), and
wherein the monomer exhibits an activation temperature (at which the acid is generated or released and/or the blowing agent is generated or released) of greater than T_{g}, but less than Tₘ.

17. The composition of claim 1, wherein the matrix polymer exhibits a glass transition temperature (T_{g}) and a melting temperature (Tₘ), and
wherein when the composition is heated to a temperature greater than T_{g}, but less than Tₘ, the monomer generates or releases the acid, the monomer generates or releases the blowing agent, or a combination thereof.

18. The composition of claim 1, wherein the triggerable polymer is present in the polymeric composition in an amount of from 1% by weight to 25% by weight, based on the total weight of the polymeric composition.

19. The composition of claim 1, wherein the matrix polymer exhibits a glass transition temperature (T_{g}) and a melting temperature (Tₘ), and
wherein when the composition is heated to a temperature greater than T_{g}, but less than Tₘ in the presence of water, the matrix polymer undergoes depolymerization.

20. An article formed, at least in part, from the composition of claim 1.

21. A method for recycling the polymeric composition of claim 1, comprising heating the composition of claim 1 to a temperature greater than an activation temperature of the monomer (at which the acid is generated or released and/or the blowing agent is generated or released) in the presence of water.

22. A method for recycling the polymeric composition of claim 1, comprising heating the composition of claim 1 to a temperature greater than a glass transition temperature (T_{g}) of the matrix polymer but less than a melting temperature (Tₘ) of the matrix polymer in the presence of water.
